(19) United States
(12) Patent Application Publication
(10) Pub. No.: US 2026/0313389 A1
(43) Pub. Date: Oct. 8, 2026

(54) SCANNING A PLURALITY OF WI-FI CHANNELS BASED ON A POWER DENSITY SCAN OF THE WI-FI CHANNELS

(71) Applicant: Microchip Technology Inc., Chandler, AZ (US)

(72) Inventors: Ajay Singh Kathat, Chandler, AZ (US); Hermanth Tenkod, Chandler, AZ (US)

(73) Assignee: Microchip Technology Inc., Chandler, AZ (US)

(21) Appl. No.: 19/262,478

(22) Filed: Jul. 8, 2025

Related U.S. Application Data
(60) Provisional application No. 63/783,016, filed on Apr. 3, 2025.

(51) Int. Cl. H04W 24/02; H04W 84/12; H04W 88/08

(52) U.S. Cl. CPC H04W 24/02; H04W 84/12; H04W 88/08

(57) ABSTRACT

A system and method for performing a channel scan based on a power level of a signal from a Wi-Fi access point are disclosed. The method may include performing a spectrum scan of a plurality of Wi-Fi channels. The method may also include calculating a power density of the plurality of Wi-Fi channels. The method may additionally include creating a table of the plurality of Wi-Fi channels. The table may order the plurality of Wi-Fi channels based on the power density of the plurality of Wi-Fi channels.

### PRIORITY

This application claims priority to U.S. Provisional Patent Application No. 63/783,016 filed Apr. 3, 2025, the contents of which are hereby incorporated in their entirety.

### TECHNICAL FIELD

The present disclosure relates to Wi-Fi communications, and in particular, to a system and method for performing a channel scan based on a power level of a signal from a Wi-Fi access point.

### BACKGROUND

A Wi-Fi device initiates a channel scan by tuning its radio receiver through each available channel, in a sequential or fixed order, within the designated frequency band, such as 2.4 GHz or 5 GHz. As the Wi-Fi device switches channels, the Wi-Fi device listens for Wi-Fi signals, particularly beacon frames broadcast by access points. After detecting a signal, the Wi-Fi device analyzes the signal strength (e.g., received signal strength indicator (RSSI)) and decodes information like the network’s service set identifier (SSID) and security protocols. The process of tuning, detecting, and analyzing is repeated across all channels, compiling a list of nearby networks with the respective details of the nearby networks. The gathered data, including SSIDs, channel numbers, and signal strengths, is then presented to the user, allowing for network selection, optimization, or troubleshooting.

### SUMMARY OF THE INVENTION

Aspects provide systems and methods for performing a channel scan based on a power level of a signal from a Wi-Fi access point. Examples of the present disclosure may include a system. The system may include a PHY circuit.

The system may also include a media access control (MAC) circuit communicatively coupled to the PHY circuit, the MAC circuit containing a look up table.

The system may further include a control circuit. The control circuit may be to instruct the PHY circuit to perform a spectrum scan of a plurality of Wi-Fi channels. The control circuit may also be to calculate a power density of the plurality of Wi-Fi channels. The control circuit may additionally be to populate the look up table of the plurality of Wi-Fi channels. The look up table may order the plurality of Wi-Fi channels based on the power density of the plurality of Wi-Fi channels.

In combination with any of the above examples, the control circuit may be to determine whether the spectrum scan captured a bandwidth of a Wi-Fi frequency band. The control circuit may also be to perform, based on the determination, a second spectrum scan of a second plurality of Wi-Fi channels. The second plurality of Wi-Fi channels may be different from the plurality of Wi-Fi channels. The spectrum scan and the second spectrum scan may capture the bandwidth of the Wi-Fi frequency band.

In combination with any of the above examples, the spectrum scan may be performed for a duration such that the PHY circuit receives a beacon signal from an access point.

In combination with any of the above examples, the control circuit may be to publish the look up table for access by an external entity.

In combination with any of the above examples, the control circuit may be to instruct the PHY circuit to scan the plurality of Wi-Fi channels in an order specified by the look up table.

In combination with any of the above examples, the look up table may be ordered from a first channel of the plurality of Wi-Fi channels having a highest power density to a second channel of the plurality of Wi-Fi channels having a lowest power density.

Alone or in combination with any of the above examples, examples of the present disclosure may include a method. The method may include performing a spectrum scan of a plurality of Wi-Fi channels. The method may also include calculating a power density of the plurality of Wi-Fi channels. The method may additionally include creating a table of the plurality of Wi-Fi channels. The table may order the plurality of Wi-Fi channels based on the power density of the plurality of Wi-Fi channels.

In combination with any of the above examples, the method may include determining whether the spectrum scan captured a bandwidth of a Wi-Fi frequency band. The method may also include performing, based on the determination, a second spectrum scan of a second plurality of Wi-Fi channels. The second plurality of Wi-Fi channels may be different from the plurality of Wi-Fi channels. The spectrum scan and the second spectrum scan may capture the bandwidth of the Wi-Fi frequency band.

In combination with any of the above examples, the spectrum scan may be performed for a duration such that the PHY circuit receives a beacon signal from an access point.

In combination with any of the above examples, the method may include publishing the table for access by an external entity.

In combination with any of the above examples, the method may include instructing the PHY circuit to scan the plurality of Wi-Fi channels in an order specified by the look up table.

In combination with any of the above examples, the table may be ordered from a first channel of the plurality of Wi-Fi channels having a highest power density to a second channel of the plurality of Wi-Fi channels having a lowest power density.

In combination with any of the above examples, the table may include, for a channel of the plurality of Wi-Fi channels, an entry containing information about the channel.

Alone or in combination with any of the above examples, examples of the present disclosure may include an apparatus. The apparatus may include a look up table.

The apparatus may also include a control circuit. The control circuit may be to perform a spectrum scan of a plurality of Wi-Fi channels. The control circuit may also be to calculate a power density of the plurality of Wi-Fi channels. The control circuit may additionally be to populate the look up table of the plurality of Wi-Fi channels, the look up table ordering the plurality of Wi-Fi channels based on the power density of the plurality of Wi-Fi channels.

In combination with any of the above examples, the control circuit may be to determine whether the spectrum scan captured a bandwidth of a Wi-Fi frequency band. The control circuit may also be to perform, based on the determination, a second spectrum scan of a second plurality of Wi-Fi channels. The second plurality of Wi-Fi channels may be different from the plurality of Wi-Fi channels. The spectrum scan and the second spectrum scan may capture the bandwidth of the Wi-Fi frequency band.

In combination with any of the above examples, the spectrum scan may be performed for a duration such that the PHY circuit receives a beacon signal from an access point.

In combination with any of the above examples, the control circuit may be to publish the look up table for access by an external entity.

In combination with any of the above examples, the control circuit may be to instruct the PHY circuit to scan the plurality of Wi-Fi channels in an order specified by the look up table.

In combination with any of the above examples, the look up table may be ordered from a first channel of the plurality of Wi-Fi channels having a highest power density to a second channel of the plurality of Wi-Fi channels having a lowest power density.

In combination with any of the above examples, the look up table may include, for a channel of the plurality of Wi-Fi channels, an entry containing information about the channel.

### BRIEF DESCRIPTION OF THE DRAWINGS

The figures illustrate examples of systems and methods for performing a channel scan based on a power level of a signal from a Wi-Fi access point.

FIG. 1 illustrates a block diagram of a Wi-Fi network, according to examples of the present disclosure;

FIG. 2 illustrates a block diagram of a Wi-Fi device for performing a channel scan based on a power level of a signal from a Wi-Fi access point, according to examples of the present disclosure;

FIG. 3 illustrates a method for performing a channel scan based on a power level of a signal from a Wi-Fi access point, according to examples of the present disclosure; and

FIG. 4 illustrates a more detailed method for performing a channel scan based on a power level of a signal from a Wi-Fi access point, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system and method for performing a channel scan based on a power level of a signal from a Wi-Fi access point are provided. The capabilities of radiofrequency (RF) subsystems increase, such as, but not limited to, analog-to-digital converter (ADC) sampling rate increases, receiver sensitivity increases, and improved processing capabilities, with a given Wi-Fi generation. The disclosed system and method may leverage the improvements to the RF subsystems, along with channel bonding features, to perform a power spectral density scan of the bands. The disclosed system and method may reduce power consumption of the Wi-Fi device during the channel scanning process, increase the probability of a stronger connection with the likely host (e.g., access point), reduce the time to perform a channel scan, and dynamically decide the order in which channels are scanned instead of using a fixed, predetermined order.

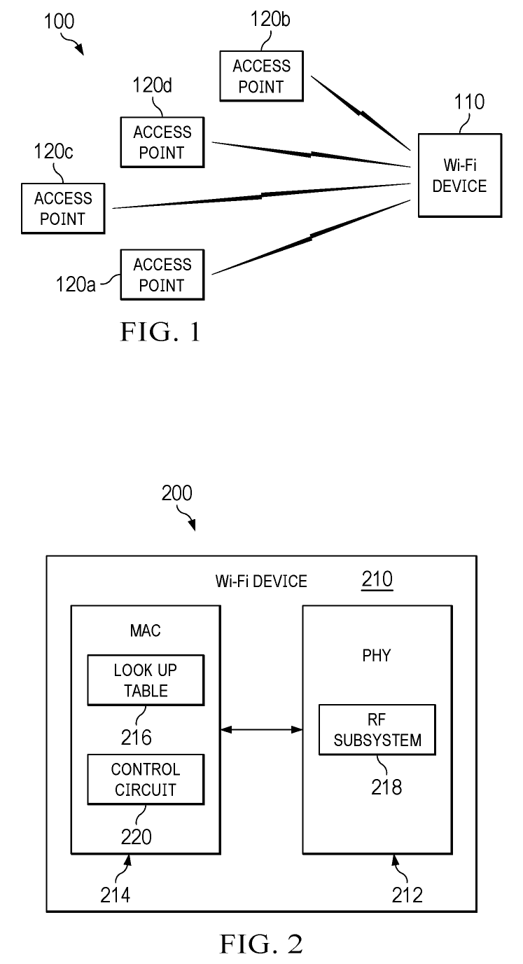

FIG. 1 illustrates a block diagram of a Wi-Fi network, according to examples of the present disclosure. Network 100 may include Wi-Fi device 110 and a plurality of access points 120. Access points 120 may be located at varying distances from Wi-Fi device 110.

Wi-Fi device 110 may be any suitable piece of electronic equipment capable of exchanging data wirelessly with other devices or a network access point (e.g., access points 120) using the suite of Institute of Electrical and Electronics Engineers (IEEE) 802.11 networking standards. For example, Wi-Fi device 110 may be a smartphone, laptop computer, smart television, or tablet computer. Wi-Fi device 110 may contain a radio transceiver and an antenna that allow it to send and receive information via radio waves, typically operating in any of the Wi-Fi frequency bands (e.g., the 2.4 gigahertz (GHz), 5 GHz, or 6 GHz frequency bands). Wi-Fi device 110 is described in further detail with respect to FIG. 2.

Access points 120 may be an item of networking hardware that establishes a wireless local area network (WLAN), allowing Wi-Fi device 110 to connect to a wired network infrastructure, and typically through that, to the internet. Access points 120 may function as a central hub and may broadcast wireless signals on specific radio frequencies corresponding to the Wi-Fi frequency bands. Access points 120 may act as a bridge, translating data between the wireless signals of the connected devices and the cabled Ethernet network.

Wi-Fi device 110 may perform a channel scan to discover access points 120 and determine which of access points 120a, 120b, 120c, or 120d to connect. As described in further detail below, Wi-Fi device 110 may perform a power sweep of the channels in the Wi-Fi frequency band. Wi-Fi device 110 may populate a table of the channels. The order of channels identified in the table may be based on the power level of the swept channels. Wi-Fi device 110 may then perform a channel scan of the channels in the order in which the channels appear in the table. By scanning the channels in order of the power level of the channels, Wi-Fi device 110 may perform the scan in less time and using less power during the scan.

FIG. 2 illustrates a block diagram of a Wi-Fi device for performing a channel scan based on a power level of a signal from a Wi-Fi access point, according to examples of the present disclosure. Wi-Fi device 210 may include physical layer (PHY) circuit 212 and media access control (MAC) layer circuit 214. MAC circuit 214 may include channel look up table 216 that is populated based on a power sweep of Wi-Fi channels.

PHY circuit 212 may include network components, such as radiofrequency (RF) transceivers, that enable data transmission over a communication medium. PHY circuit 212 may be communicatively coupled to the communication medium. In some examples, PHY circuit 212 may include an analog-to-digital converter (ADC).

MAC circuit 214 may manage access to the communication medium. In some examples, the Wi-Fi device may implement the MAC layer by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. The MAC layer may be implemented by instructions for execution by a processor through, for example, a function, application programming interface (API) call, script, program, compiled code, interpreted code, binary, executable, executable file, firmware, object file, container, assembly code, or object. For example, the MAC layer may be implemented by instructions stored in a non-transitory medium such as a memory that, when loaded and executed by a processor such as a central processing unit (CPU) (or any other suitable process), cause the functionality of the MAC layer herein.

PHY circuit 212 may perform a power sweep of the available Wi-Fi channels in a Wi-Fi frequency band. Specifically, PHY circuit 212 may tune to a center frequency of a given channel in the Wi-Fi frequency band and capture any radio frequency (RF) energy present on the tuned channel. For example, PHY circuit 212 may sweep the channels using RF subsystem 218 in PHY circuit 212. RF subsystem 218 may perform a spectrum scan for a duration long enough to receive the beacon signal of the access point in the air. For example, the access point may transmit the beacon signal (e.g., a small data packet announcing the presence of the access point to nearby devices) periodically (e.g., every 102.4 milliseconds (ms)). RF subsystem 218 may use a small buffer time (e.g., 5 ms). The buffer time may be added to the beacon signal to ensure that the scan time is long enough to receive beacons from the access points in the area surrounding PHY circuit 212 due to the access points running at different intervals (e.g., a given access point may not emit a beacon signal at the same time another access point emits a beacon signal). RF subsystem 218 may have a higher sampling rate to support channel bonding (e.g., 40 megahertz (MHz), 80 MHz, 160 MHz). For example, RF subsystem 218 may have a sampling rate that is at least twice the bandwidth of the channel. If the power spectral density scan is performed with 160 MHz bandwidth, the scan may cover the 2.4 GHz Wi-Fi band (e.g., the 2.4 GHz band covers a 100 MHz range of 2400 MHz to 2500 MHz, equivalent to 2.4 GHz to 2.5 GHz).

After capturing the RF energy for one channel, PHY circuit 212 may proceed to the next channel. PHY circuit 212 may tune to a center frequency of the next channel in the Wi-Fi frequency band and capture any radio frequency (RF) energy present on that channel. PHY circuit 212 may proceed through the channels of the Wi-Fi frequency band until the frequency band has been scanned. Therefore, RF subsystem 218 may be able to capture the bandwidth of the available Wi-Fi channels.

In some examples, RF subsystem 218 may leverage channel bonding techniques to facilitate the power sweep. Channel bonding techniques may be used to combine multiple 20 MHz channels into a wider channel (e.g., 40 MHz, 80 MHz, 160 MHz) to efficiently perform the power sweep. However, for higher Wi-Fi frequency bands (e.g., 5 GHz, 6 GHz) the full Wi-Fi frequency band may not be scanned in one power sweep. In this example, the power scan may be repeated until the full Wi-Fi frequency band is captured in one or more power sweeps.

PHY circuit 212 may report the results of the power sweep to MAC circuit 214. MAC circuit 214 may perform a power density calculation using the frequency domain to calculate the power spectral density of the signal at a given channel (e.g., using a Fourier transform in the frequency domain to determine the spectral density).

Using the power density calculation, MAC circuit 214 may populate channel look up table 216. Channel look up table 216 may be stored in memory of MAC circuit 214, for example, read-only memory (ROM), random access memory (e.g., RAM, SRAM, DRAM), electrically erasable programmable read-only memory (EEPROM), a Personal Computer Memory Card International Association (PCMCIA) card, flash memory, magnetic storage, opto-magnetic storage, hardware registers, and/or any suitable selection or array of volatile or non-volatile memory.

Channel look up table 216 may include the channels from the power sweep by PHY circuit 212, ordered according to the detected power level of a given channel (e.g., in descending power level order). Specifically, MAC circuit 214 may include control circuit 220 to perform the power density calculation and populate look up table 216. Control circuit 220 may be implemented by instructions for execution by a processor, analog circuitry, digital circuitry, control logic, digital logic circuits programmed through hardware description language, ASICs, FPGAs, PLDs, or any suitable combination thereof, whether in a unitary device or spread over several devices. Control circuit 220 may be implemented by instructions for execution by a processor through, for example, a function, API call, script, program, compiled code, interpreted code, binary, executable, executable file, firmware, object file, container, assembly code, or object. For example, control circuit 220 may be implemented by instructions stored in a non-transitory medium such as a memory that, when ed and executed by a processor such as a CPU (or any other suitable process), cause the functionality of control circuit 220 herein.

In some examples, channel look up table 216 may include additional information or links to a descriptor table containing additional information about the channels in the look up table. Where MAC 214 may be capable of parsing the channel scan data, MAC 214 may decode the data and detect additional information about the channel, such as a Wi-Fi preamble and beacon information (e.g., number of beacons in each channel, service set identifier (SSID), security information, received signal strength indicator (RSSI) information). For example, the additional information may include the SSIDs of the channels. In some examples, channel look up table 216 may be based on other information in addition to, or instead of, the power level of the scanned channels. For example, the data may be decoded and used to identify an information element of the access point. As another example, the energy of a particular channel may be used to determine the beacon data of an access point. The details of the beacon (e.g., SSID, security information, RSSI information) may be used to form channel look up table 216.

As an example of channel look up table 216, a given entry in channel look up table 216 may have a size of 32 bits for a given channel. The number of entries in channel lookup table 216 may vary based on the number of channels supported by the regulatory domain in which system 200 is operating. As an example of an entry in channel lookup table, the start of channel look up table 216 may include SRAM address 0x80001000. For a given entry, channel look up table 216 may include the power level of the channel (e.g., in decibels relative to one milliwatt (dBm)), the number of beacons, the maximum security level, and any other suitable information. The length of a given entry or field in channel look up table 216 may increase or decrease based on the scanning capability of the hardware used in system 200.

Once control circuit 220 populates channel look up table 216, MAC circuit 214 may direct PHY circuit 212 to perform a channel scan of the channels in a Wi-Fi frequency band based on the order in channel look up table 216. For example, rather than performing a channel scan in a sequential manner (e.g., channel 1, channel 2, channel 3 through channel 14), a user or application layer of PHY circuit 212 may perform the channel scan according to the order in which the channels are listed in channel look up table 216. Specifically, PHY circuit 212 may begin the channel scan with the higher power channels to identify a stronger access point with which to connect.

In some examples, a user or application layer of PHY circuit 212 may scan a subset of the channels in channel look up table 216. For example, control circuit 220 of MAC circuit 214 may establish a threshold and channels having a power level below the threshold may not be included in the channel scan. The threshold may depend on the system or situation in which Wi-Fi device 210 is used and may be configurable by a user of Wi-Fi device 210. For example, if Wi-Fi device 210 is used in a cloud environment, the threshold may be higher. However, if Wi-Fi device 210 is used in an environment where the location of Wi-Fi device 210 is fixed (e.g., a warehouse), the threshold may be lower. As another example, Wi-Fi device 210 may stop the channel scan once it identifies the intended access point. Therefore, Wi-Fi device 210 may avoid unnecessary scanning of less relevant channels.

By performing the channel scan in an order of descending channel power level, the probability that MAC circuit 214 identifies the intended access point may occur in less time and improve connection functionality. For example, in some cases, Wi-Fi device 210 may be close to the intended access point and the intended access point may have a higher power level relative to other access points that are further away from Wi-Fi device 210. Referring to the example shown in FIG. 1, access point 120a may be the intended access point for Wi-Fi device 110. Access point 120a may have a higher power level and may appear earlier in channel look up table 216 than access points 120b, 120c, and 120d. Therefore, Wi-Fi device 110 may scan access point 120a before scanning access points 120b, 120c, and 120d.

Additionally, MAC circuit 214 may consume less power during the channel scan because the intended access point may be identified in less time and MAC circuit 214 may end the channel scan once the intended access point is identified. Further, MAC circuit 214 may not scan channels with lower power levels to which Wi-Fi device 210 is less likely to connect.

In some examples, an access point, such as access points 120 shown in FIG. 1, may include the ability to publish channel look up table 216 for access by other devices external to Wi-Fi device 110. For example, some Wi-Fi devices may not include the capability to perform power density calculations and populate channel look up tables. Therefore, the access point may publish channel look up table 216 to the external entities through information elements (IEs). The external entities may receive the channel look up table from the access point and use the channel look up table to do a channel scan in the order in which channels are listed in the channel look up table. In some examples, Wi-Fi device 110, in addition to or instead of the access point, may share the channel look up table with the external entities. Specifically, the access point may perform a scan similar to the scan performed by Wi-Fi device 210. The access point may maintain a local channel look up table similar to channel look up table 216. The access point may share the local channel look up table periodically in its beacon or in other management frames (e.g., probe response, association response) when requested from an external entity.

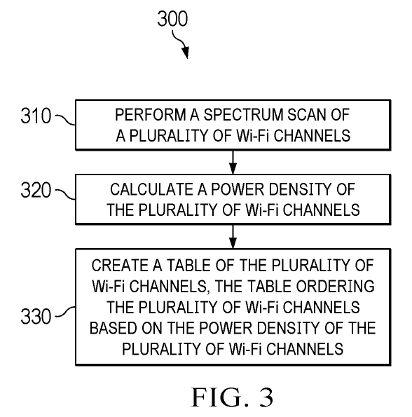

FIG. 3 illustrates a method for performing a channel scan based on a power level of a signal from a Wi-Fi access point, according to examples of the present disclosure. Method 300 may be implemented by a Wi-Fi device, such as Wi-Fi device 110 or Wi-Fi device 210 shown in FIGS. 1 and 2, respectively. The Wi-Fi device may include a PHY circuit (e.g., PHY circuit 212 shown in FIG. 2) and a MAC circuit (e.g., MAC circuit 214 shown in FIG. 2). The MAC circuit may include a channel look up table (e.g., channel look up table 216 shown in FIG. 2) and a control circuit (e.g., control circuit 220 in FIG. 2). Although examples have been described above, other variations and examples may be made from this disclosure without departing from the spirit and scope of these disclosed examples.

Method 300 may begin at block 310, where the Wi-Fi device may perform a spectrum scan of a plurality of Wi-Fi channels. The spectrum scan may be a power sweep of the available Wi-Fi channels in a Wi-Fi frequency band. The spectrum scan may be performed using a PHY circuit in the Wi-Fi device. The results of the spectrum scan may be provided to a MAC circuit in the Wi-Fi device. The spectrum scan may capture the RF energy of a first channel in the Wi-Fi frequency band and then proceed to capture the RF energy of a second channel in the Wi-Fi frequency band, continuing through the channels in the Wi-Fi frequency band.

At block 320, the Wi-Fi device may calculate a power density of the plurality of Wi-Fi channels. A control circuit in the MAC circuit of the Wi-Fi device may perform a power density calculation using the frequency domain to calculate the power spectral density of the signal at a given channel (e.g., using a Fourier transform in the frequency domain to determine the spectral density).

At block 330, the Wi-Fi device may populate a table of the plurality of Wi-Fi channels. The table may order the plurality of Wi-Fi channels based on the power density of the plurality of Wi-Fi channels. For example, using the power density calculation, the control circuit may populate a channel look up table listing the plurality of Wi-Fi channels. The channel look up table may order the plurality of Wi-Fi channels in a descending power level order where a channel of the plurality of Wi-Fi channels having a highest power density is listed first in the channel look up table and a channel of the plurality of Wi-Fi channels having a lowest power density is listed last in the channel look up table. The channel look up table may be saved in a memory in the Wi-Fi device.

Although FIG. 3 discloses a particular number of operations related to method 300, method 300 may be executed with greater or fewer operations than those depicted in FIG. 3. In addition, although FIG. 3 discloses a certain order of operations to be taken with respect to method 300, the operations comprising method 300 may be completed in any suitable order.

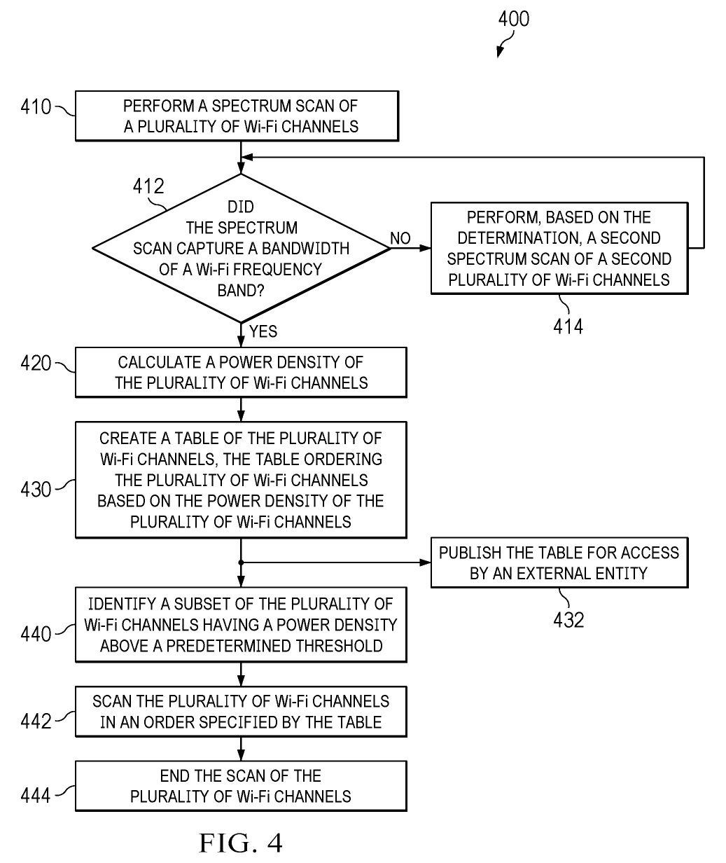

FIG. 4 illustrates a more detailed method for performing a channel scan based on a power level of a signal from a Wi-Fi access point, according to examples of the present disclosure. Method 400 may be implemented by a Wi-Fi device, such as Wi-Fi device 110 or Wi-Fi device 210 shown in FIGS. 1 and 2, respectively. The Wi-Fi device may include a PHY circuit (e.g., PHY circuit 212 shown in FIG. 2) and a MAC circuit (e.g., MAC circuit 214 shown in FIG. 2). The MAC circuit may include a channel look up table (e.g., channel look up table 216 shown in FIG. 2) and a control circuit (e.g., control circuit 220 in FIG. 2). Although examples have been described above, other variations and examples may be made from this disclosure without departing from the spirit and scope of these disclosed examples.

Method 400 may begin at block 410, where the Wi-Fi device may perform a spectrum scan of a plurality of Wi-Fi channels. The spectrum scan may be a power sweep of the available Wi-Fi channels in a Wi-Fi frequency band. The spectrum scan may be performed using a PHY circuit in the Wi-Fi device. The results of the spectrum scan may be provided to a MAC circuit in the Wi-Fi device. The spectrum scan may capture the RF energy of a first channel in the Wi-Fi frequency band and then proceed to capture the RF energy of a second channel in the Wi-Fi frequency band, continuing through the channels in the Wi-Fi frequency band. The spectrum scan may be performed for a duration long enough to receive the beacon signal of the access point in the air.

At block 412, the Wi-Fi device may determine whether the spectrum scan captured a bandwidth of a Wi-Fi frequency band. For example, for higher Wi-Fi frequency bands (e.g., 5 GHz, 6 GHz) the full Wi-Fi frequency band may not be scanned in one spectrum scan (e.g., one power sweep). Therefore, the Wi-Fi device may determine whether the spectrum scan captured a subset of the channels in of the Wi-Fi frequency band. If the spectrum scan captured the full bandwidth of the Wi-Fi frequency band, method 400 may proceed to block 420. If the spectrum scan did not capture the full bandwidth of the Wi-Fi frequency band, method 400 may proceed to block 414.

At block 414, the Wi-Fi device may perform a second spectrum scan of a second plurality of Wi-Fi channels. The second plurality of Wi-Fi channels may be different from the plurality of Wi-Fi channels scanned at block 410. Therefore, a broader range of the bandwidth of the Wi-Fi frequency band is scanned. After performing the second spectrum scan, method 400 may return to block 412 to determine if, between the spectrum scan of block 410 and the spectrum scan of block 414, the full bandwidth of the Wi-Fi frequency band has been scanned. Method 400 may repeat blocks 412 and 414 until the full bandwidth of the Wi-Fi frequency band has been scanned.

At block 420, the Wi-Fi device may calculate a power density of the plurality of Wi-Fi channels. A control circuit in the MAC circuit of the Wi-Fi device may perform a power density calculation using the frequency domain to calculate the power spectral density of the signal at a given channel (e.g., using a Fourier transform in the frequency domain to determine the spectral density).

At block 430, the Wi-Fi device may populate a table of the plurality of Wi-Fi channels. The table may order the plurality of Wi-Fi channels based on the power density of the plurality of Wi-Fi channels. For example, using the power density calculation, the control circuit may populate a channel look up table listing the plurality of Wi-Fi channels. The channel look up table may order the plurality of Wi-Fi channels in a descending power level order where a channel of the plurality of Wi-Fi channels having a highest power density is listed first in the channel look up table and a channel of the plurality of Wi-Fi channels having a lowest power density is listed last in the channel look up table. The channel look up table may be saved in a memory in the Wi-Fi device.

In some examples, table populated at block 430 may include additional information about the channels in the look up table or entries (e.g., links) to a descriptor table containing additional information about the channels in the look up table. Where MAC 214 may be capable of parsing the channel scan data, MAC 214 may decode the data and detect additional information about the channel, such as a Wi-Fi preamble and beacon information (e.g., number of beacons in each channel, SSID, security information, RSSI information). For example, the additional information may include the SSIDs of the channels. In some examples, the table may be based on other information in addition to, or instead of, the power level of the scanned channels. For example, the data may be decoded and used to identify an information element of the access point. As another example, the energy of a particular channel may be used to determine the beacon data of an access point. The details of the beacon (e.g., SSID, security information, RSSI information) may be used to form the table.

At block 432, the Wi-Fi device may publish the table for access by an external entity. The external entity may be any suitable entity, such as, but not limited to, a software or firmware device driver or external hardware. For example, some Wi-Fi devices may not include the capability to perform power density calculations and populate channel look up tables. Therefore, the Wi-Fi device may publish the channel look up table to the external entities through information elements (IEs). The external entities may receive the channel look up table from the access point and use the channel look up table to do a channel scan in the order in which channels are listed in the channel look up table.

At block 440, the Wi-Fi device may identify a subset of the plurality of Wi-Fi channels having a power density above a predetermined threshold. The Wi-Fi device may scan a subset of the channels in the channel look up table. For example, a user or application layer of the MAC circuit may establish the predetermined threshold and channels having a power level below the predetermined threshold may not be included in the channel scan. The predetermined threshold may depend on the system or situation in which the Wi-Fi device is used and may be configurable by a user of the Wi-Fi device.

At block 442, the Wi-Fi device may scan the plurality of Wi-Fi channels in an order specified by the table. For example, rather than performing a channel scan in a sequential manner (e.g., channel 1, channel 2, channel 3 through channel 14), a user or application layer of the MAC circuit may instruct the PHY circuit to perform the channel scan according to the order in which the channels are listed in the channel look up table. Specifically, a user or application layer of the PHY circuit may begin the channel scan with the higher power channels to identify a stronger access point with which to connect.

At block 444, the Wi-Fi device may end the scan of the plurality of Wi-Fi channels. For example, the Wi-Fi device may stop the scan once the Wi-fi device scans the channels having a power level above the predetermined threshold or finds the intended access point. Therefore, Wi-Fi device 210 may avoid unnecessary scanning of less relevant channels.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

Although examples have been described above, other variations and examples may be made from this disclosure without departing from the spirit and scope of these disclosed examples.

1. A system, comprising:
a PHY circuit;
a media access control (MAC) circuit communicatively coupled to the PHY circuit, the MAC circuit containing a look up table; and
a control circuit, the control circuit to:
instruct the PHY circuit to perform a spectrum scan of a plurality of Wi-Fi channels;
calculate a power density of the plurality of Wi-Fi channels; and
populate the look up table of the plurality of Wi-Fi channels, the look up table ordering the plurality of Wi-Fi channels based on the power density of the plurality of Wi-Fi channels.

2. The system of claim 1, wherein the control circuit is to:
determine whether the spectrum scan captured a bandwidth of a Wi-Fi frequency band; and
perform, based on the determination, a second spectrum scan of a second plurality of Wi-Fi channels;
wherein:
the second plurality of Wi-Fi channels is different from the plurality of Wi-Fi channels; and
the spectrum scan and the second spectrum scan capture the bandwidth of the Wi-Fi frequency band.

3. The system of claim 1, wherein the spectrum scan is performed for a duration such that the PHY circuit receives a beacon signal from an access point.

4. The system of claim 1, wherein the control circuit is to publish the look up table for access by an external entity.

5. The system of claim 1, wherein the control circuit is to instruct the PHY circuit to scan the plurality of Wi-Fi channels in an order specified by the look up table.

6. The system of claim 1, wherein the look up table is ordered from a first channel of the plurality of Wi-Fi channels having a highest power density to a second channel of the plurality of Wi-Fi channels having a lowest power density.

7. A method, comprising:
performing a spectrum scan of a plurality of Wi-Fi channels;
calculating a power density of the plurality of Wi-Fi channels; and
creating a table of the plurality of Wi-Fi channels, the table ordering the plurality of Wi-Fi channels based on the power density of the plurality of Wi-Fi channels.

8. The method of claim 7, comprising:
determining whether the spectrum scan captured a bandwidth of a Wi-Fi frequency band; and
performing, based on the determination, a second spectrum scan of a second plurality of Wi-Fi channels;
wherein:
the second plurality of Wi-Fi channels is different from the plurality of Wi-Fi channels; and
the spectrum scan and the second spectrum scan capture the bandwidth of the Wi-Fi frequency band.

9. The method of claim 7, wherein the spectrum scan is performed for a duration such that the PHY circuit receives a beacon signal from an access point.

10. The method of claim 7, comprising publishing the table for access by an external entity.

11. The method of claim 7, comprising instructing the PHY circuit to scan the plurality of Wi-Fi channels in an order specified by the look up table.

12. The method of claim 7, wherein the table is ordered from a first channel of the plurality of Wi-Fi channels having a highest power density to a second channel of the plurality of Wi-Fi channels having a lowest power density.

13. The method of claim 7, wherein the table includes, for a channel of the plurality of Wi-Fi channels, an entry containing information about the channel.

14. An apparatus, comprising:
a look up table; and
a control circuit, the control circuit to:
perform a spectrum scan of a plurality of Wi-Fi channels;
calculate a power density of the plurality of Wi-Fi channels; and
populate the look up table of the plurality of Wi-Fi channels, the look up table ordering the plurality of Wi-Fi channels based on the power density of the plurality of Wi-Fi channels.

15. The apparatus of claim 14, wherein the control circuit is to:
determine whether the spectrum scan captured a bandwidth of a Wi-Fi frequency band; and
perform, based on the determination, a second spectrum scan of a second plurality of Wi-Fi channels;
wherein:
the second plurality of Wi-Fi channels is different from the plurality of Wi-Fi channels; and
the spectrum scan and the second spectrum scan capture the bandwidth of the Wi-Fi frequency band.

16. The apparatus of claim 14, wherein the spectrum scan is performed for a duration such that the PHY circuit receives a beacon signal from an access point.

17. The apparatus of claim 14, wherein the control circuit is to publish the look up table for access by an external entity.

18. The apparatus of claim 14, wherein the control circuit is to instruct the PHY circuit to scan the plurality of Wi-Fi channels in an order specified by the look up table.

19. The apparatus of claim 14, wherein the look up table is ordered from a first channel of the plurality of Wi-Fi channels having a highest power density to a second channel of the plurality of Wi-Fi channels having a lowest power density.

20. The apparatus of claim 14, wherein the look up table includes, for a channel of the plurality of Wi-Fi channels, an entry containing information about the channel.
